(19) United States
(12) Patent Application Publication
(10) Pub. No.: US 2019/0097830 A1
(43) Pub. Date: Mar. 28, 2019

(54) METHOD FOR REMOTELY CONTROLLING CONNECTION TO ACCESS POINT, AND HOME DEVICE IN WHICH METHOD FOR REMOTELY CONTROLLING CONNECTION TO ACCESS POINT IS IMPLEMENTED

(71) Applicant: Kyung Dong One Corporation, Seoul (KR)

(72) Inventor: Young Je Ha, Seoul (KR)

(73) Assignee: Kyung Dong One Corporation

(21) Appl. No.: 16/139,525

(22) Filed: Sep. 24, 2018

Related U.S. Application Data
(63) Continuation of application No. PCT/KR2017/000301, filed on Jan. 10, 2017.

(30) Foreign Application Priority Data
Mar. 29, 2016 (KR) 10-2016-0037884

(51) Int. Cl. H04L 12/28; H04W 12/06; H04W 12/08; H04B 17/318; H04W 4/80; H04W 88/08

(52) U.S. Cl. CPC H04L 12/2816; H04W 12/06; H04W 12/08; H04L 2012/2841; H04W 4/80; H04W 88/08; H04B 17/318

(57) ABSTRACT

Disclosed are an access point access remote management method for allowing a device as a remote control target to attempt to access only an access point present within an accessible range, in remotely controlling an access point access setting of a device available for performing wireless communication such as a household boiler, or the like, and a home device in which the access point access remote management method is implemented. The home device in which an access point access remote management method is implemented includes a first communication interface unit transmitting and receiving data to and from an access point (AP) and smart devices on the basis of Wi-Fi communication; a virtual AP driving unit implementing an AP function to allow a smart device to be connected via the first communication interface unit; an AP scanning unit collecting information of APs present within an accessible range by the first communication interface unit; an AP list generating unit generating a list of the APs on the basis of the collected information of the APs; a memory unit storing a program such as software or firmware required for an operation, data generated during execution of the program, and a unique code; and a controller controlling a general operation required for performing the AP access remote management method.

### CROSS-REFERENCE TO RELATED APPLICATIONS

This application is a continuation application of International Application No. PCT/KR2017/000301 filed on Jan. 10, 2017, which claims priority to Korean Application No. 10-2016-0037884 filed on Mar. 29, 2016. The applications are incorporated herein by reference.

### TECHNICAL FIELD

The present disclosure relates to an access point access remote management method (or method for remotely managing access to an access point) and a home device in which the access point access remote management method is implemented, and more particularly, to an access point access remote management method for allowing a device as a remote control target to attempt to access only an access point present within an accessible range, in remotely controlling an access point access setting of a device available for performing wireless communication such as a household boiler, or the like, and a home device in which the access point access remote management method is implemented.

### BACKGROUND ART

Recently, household gas boilers, oil boilers, and the like, tend to have a wireless communication function such as Wi-Fi to become smart such that set values thereof are remotely controlled through an application (or app) installed in smartphones.

For example, a household boiler includes a temperature controller, which is also called a “room controller”, and recently, such a temperature controller is connected to a home Wi-Fi access point (AP) to operate through a wireless communication network, constituting a part of a home automation system.

Here, it is necessary to appropriately set the temperature controller to perform wireless communication in order to access the wireless communication network.

For example, the temperature controller may be switched to an “AP mode” allowing the temperature controller to serve as an AP in software, the temperature controller operating in the AP mode through a dedicated application installed in a smartphone, and a service set identification (SSID) and a password are transmitted to the temperature controller such that the temperature controller may access another AP (e.g., a home wireless router, etc.) intended to be accessed. Accordingly, after the temperature controller is returned from the AP mode to a normal operation mode, the temperature controller may access the home wireless router which enables the Internet using the SSID and the password received from the application of the smartphone.

According to the related art, however, if information about a wireless router, which is present within a range in which the smartphone is wirelessly accessible but is not present within a range in which the temperature controller is wirelessly accessible, is transmitted, the temperature controller may not be able to access the AP (wireless router) with the SSID and the password currently received by the temperature controller.

Similarly, according to the related art, in case where an AP is present within a range in which the temperature controller is wirelessly accessible but the AP is outside a range in which the AP is not accessible by the smartphone, the smartphone application cannot transmit an SSID and password information to the temperature controller.

Meanwhile, in order to provide a security function to prevent an unauthorized person to access the temperature controller and arbitrarily change set values of the temperature controller, a related art (Korean Patent Registration No. 10-1395289) uses random number information and MAC address information of a smart device. Even in this case, however, the problem that information regarding an AP present in a range which cannot be accessed by the temperature controller may be received remains unsolved.

In addition, some of the smart devices that have recently appeared and are equipped with an android operating system may not be able to access an AP which is not connected to the external Internet at all. If a user uses such a smart device, the smart device 1 may not be able to access a home device 2 which is operating in the “virtual AP” mode but is not connected to the external Internet.

Accordingly, there has been a request for an AP access remote management method which may solve the aforementioned problems and allow a device as a remote control target to attempt to access only an AP present within an accessible range.

### SUMMARY

The present disclosure is devised to meet the request, and an aspect of the present disclosure provides an access point access remote management method for allowing a device as a remote control target to attempt to access only an access point present within an accessible range.

According to an aspect of the present disclosure, there is provided a home device in which an access point access remote management method is implemented includes: a first communication interface unit transmitting and receiving data to and from an access point (AP) and smart devices on the basis of Wi-Fi communication; a virtual AP driving unit implementing an AP function to allow a smart device to be connected via the first communication interface unit; an AP scanning unit collecting information of APs present within an accessible range by the first communication interface unit; an AP list generating unit generating a list of the APs on the basis of the collected information of the APs; a memory unit storing a program such as software or firmware required for an operation, data generated during execution of the program, and a unique code; and a controller controlling a general operation required for performing the AP access remote management method.

According to another aspect of the present disclosure, there is provided a home device in which an access point access remote management method is implemented includes: a first communication interface unit transmitting and receiving data to and from an access point (AP) and smart devices on the basis of Wi-Fi communication; a virtual AP driving unit implementing an AP function to allow a smart device to be connected via the first communication interface unit; a second communication interface unit transmitting and receiving data to and from the AP and the smart devices on the basis of a near-field communication (NFC) protocol; an AP scanning unit collecting information of APs present within an accessible range by the first communication interface unit; an AP list generating unit generating a list of the APs on the basis of the collected information of the APs; a memory unit storing a program such as software or firmware required for an operation, data generated during execution of the program, and a unique code; and a controller controlling a general operation required for performing the AP access remote management method and selecting a communication interface to perform communication with the smart devices from among the first communication interface unit or the second communication interface unit.

Here, the information of the APs may include service set identifications (SSIDs) of the APs.

Also, the information of the APs may further include received signal strength indicators (RSSIs) of the APs.

Also, the AP list may be generated by sorting the APs in order of magnitudes of average values of RSSI values of the respective APs measured two or more times.

Meanwhile, the AP list may be generated by sorting the APs in order of magnitudes of maximum values of RSSI values of the respective APs measured two or more times.

Also, the home device may further include: a random number generating unit generating a random number used for authentication using an external authentication server.

According to another aspect of the present disclosure, there is provided an access point access remote management method including: collecting information regarding access points (APs) present within an accessible range; generating a list of the accessible APs on the basis of the collected information of the APs; transmitting the generated AP list to a connected smart device; receiving information of an AP to be accessed from the smart device; and accessing the AP to be accessed using the information of the AP to be accessed.

Here, the access point access remote management method may further include: executing a near-field communication (NFC) reception mode to allow the smart device to be connected, before the transmitting the AP list to the smart device.

Also, the access point access remote management method may further include: when connection to the smart device via an NFC protocol is not established after execution of the NFC reception mode, switching an operation mode to an AP registration mode implementing a function of an AP to allow the smart device to be connected.

Or, the access point access remote management method may further include: switching an operation mode to an AP registration mode implementing a function of an AP to allow the smart device to be connected, before transmitting the AP list to the connected smart device.

Here, the access point access remote management method may further include: terminating the AP registration mode and returning to a normal operation mode, after receiving the information of the AP to be accessed.

Also, the access point access remote management method may further include: when the smart device is not connected after the operation mode is switched to the AP registration mode, executing an NFC reception mode to allow the smart device to be connected.

Also, the information of the AP to be accessed may include a service set identification (SSID).

Also, the information of the AP to be accessed may further include a password of the AP to be accessed.

Also, the generated AP list may be transmitted to the smart device via Wi-Fi connection, and the information of the AP to be accessed may be received from the smart device via Wi-Fi connection.

Or, the generated AP list may be transmitted to the smart device via NFC connection, and the information of the AP to be accessed may be received from the smart device via NFC connection.

Or, the AP list may be generated by sorting the APs in order of magnitudes of average values of RSSI values of the respective APs measured two or more times.

Or, the AP list may be generated by sorting the APs in order of magnitudes of maximum values of RSSI values of the respective APs measured two or more times.

Also, the access point access remote management method may further include: generating a random number used for authentication using an external authentication server; and transmitting the generated random number and a unique code to the smart device.

According to the present disclosure, an access point access remote management method for allowing a device as a remote control target to attempt to access only an access point present within an accessible range, in remotely controlling an access point access setting of a device available for wireless communication such as a household boiler, or the like, may be realized.

### BRIEF DESCRIPTION OF DRAWINGS

FIG. 1 is a view illustrating an example of an environment to which an access point access remote management method is applied;

FIG. 2 is a flowchart illustrating an example of an access point access remote management method;

FIG. 3 is a flowchart illustrating another example of an access point access remote management method;

FIG. 4 is a flowchart illustrating another example of an access point access remote management method;

FIG. 5A is a flowchart illustrating another example of an access point access remote management method;

FIG. 5B is a flowchart illustrating another example of an access point access remote management method;

FIG. 6 is a flowchart illustrating an example of an access point access remote management method performed in a home device;

FIG. 7 is a flowchart illustrating another example of an access point access remote management method performed in a home device;

FIG. 8 is a flowchart specifically illustrating an example of a procedure 210 for generating an AP list;

FIG. 9 is a flowchart specifically illustrating another example of a procedure 210 for generating an AP list; and

FIG. 10 is a flowchart specifically illustrating yet another example of a procedure 210 for generating an AP list.

### DETAILED DESCRIPTION

Hereinafter, an access point access remote management method according to the present disclosure will be described in detail with reference to the drawings.

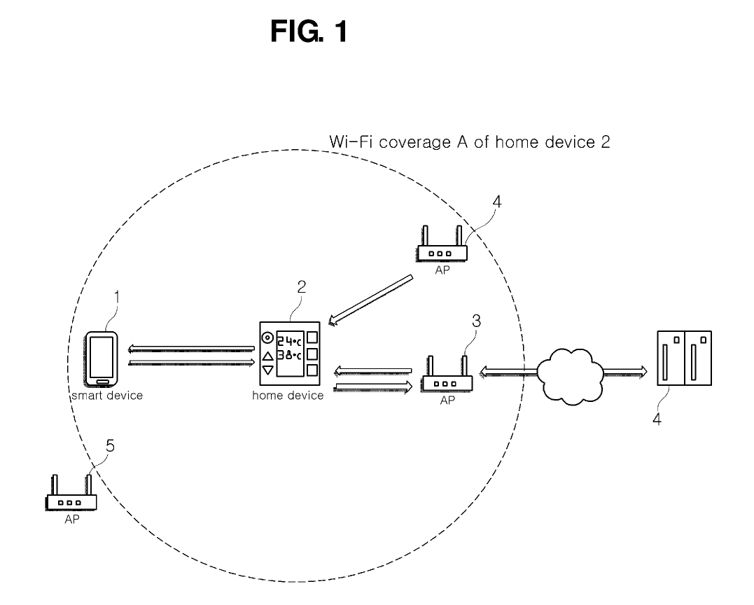

FIG. 1 is a view illustrating an example of an environment to which an access point (AP) connection remote management method is applied.

In FIG. 1, a system in which an indoor temperature controller of a boiler is an example of a home device 2 and the home device 2 is controlled by a smart device 1 so that the home device 2 may be connected to an AP 3 is illustrated.

In FIG. 1, the temperature controller 2 and the home device 2 have the same meaning.

Meanwhile, in FIG. 1, a Wi-Fi coverage A of the home device refers to a physical range in which the home device may access another device via Wi-Fi.

The home device 2 may scan APs 3 and 4 present in the coverage A to recognize which of the APs 3 and 4 is accessible. Thus, an AP 5 not positioned in the coverage A is considered as an AP which does not exist for the home device.

The home device 2 provides the smart device 1 with information about accessible APs 3 and 4 using near field communication (NFC) and receives an SSID and password information regarding a selected AP 3 from the smart device 1 using NFC.

Meanwhile, the home device 2 may serve as an AP operating by software (hereinafter, referred to as a “virtual AP”), as well as providing a Wi-Fi communication function. The home device 2 may be switched from a normal operation mode to a virtual AP mode using a menu button thereof. Thus, when connection to the smart device 1 using NFC fails or when the home device 2 wants to access the smart device 1 without using NFC, the home device 2 may access the smart device 1 by a Wi-Fi protocol using the virtual AP mode.

When the home device 2 is switched to the virtual AP mode, a user may access the home device 2 using his/her smart device 1. Also, the user may receive information regarding the APs 3 and 4 to which the home device 2 is accessible from the home device 2 (e.g., an SSID list of accessible APs and further a received signal strength indicator (RSSI) of each SSID) using a mobile application installed for Internet access management of the home device 2, and select the AP 3 desired to be connected from the list. In case where the selected AP 3 requires a password for connection, the user may input a password through the mobile application of the smartphone.

The SSID and the password regarding the selected AP 3 MAY BE transmitted to the home device 2 again and the home device 2 may access the AP 3 using the SSID and the password information. Successfully connected to the AP, the home device 2 may be connected to the external Internet and communicate with an external server 4 involved in the function of the home device 2.

By selecting the AP to which the home device 2 is accessible, among the APs 3 and 4, a phenomenon in which the user erroneously attempts to access an AP (e.g., the AP 5) which is included in the coverage of the smart device 1 connecting the home device 2 but not included in the coverage A of the home device 2 may be prevented.

Performing communication between the home device 2 and the smart device 1 using the NFC network is advantageous, compared with performing communication using a virtual AP mode.

For example, some smart devices equipped with an android operating system, among recently introduced smart devices, may be initially set not to access an AP which is not connected to the external Internet. If a user uses such a smart device, the smart device 1 cannot access the home device 2 which operates in the “virtual AP” mode but is not connected to the external Internet.

Therefore, in case where the home device 2 is not connected to the smart device 1 after the home device 2 is switched to the virtual AP mode, NFC communication may be activated by any one of the smart device 1 and the home device 2 and information for accessing the AP 3 may be exchanged using NFC communication, instead of Wi-Fi communication, whereby the home device 2 may be successfully connected to the AP 3.

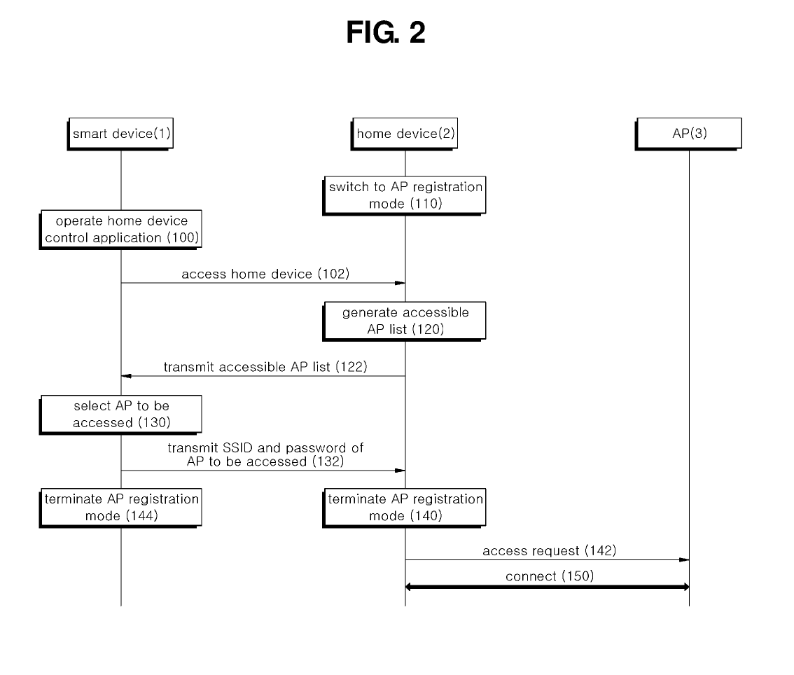

FIG. 2 is a flowchart illustrating an example of an AP access remote management method.

FIG. 2 illustrates flow of the AP access remote management method in the environment described above with reference to FIG. 1 from a vantage point of the smart device 1, the home device 2, and the AP 3.

As illustrated in FIG. 2, a state of the home device 2 is switched to an “AP registration mode” using the menu button of the home device 2, or the like (110). In this state, the home device 2 may be regarded as being in a state in which it is not connected to an Internet-accessible AP. However, the home device may already be in a state of being connected to a certain AP (regardless of whether or not the Internet is available), and the user may wants to change a connection state of the home device to another AP. Meanwhile, when the smart device 1 is connected to the home device 2 using NFC communication, the home device 2 may be automatically switched to an NFC reception mode to enter the AP registration mode, although the menu button is not pressed separately.

The smart device 1 operates (100) an application (or an “app”) for controlling the home device and is connected to the home device (102).

When the smart device 1 is connected to the home device 2, the home device 20 generates an accessible AP list (120) and transmits the generated list to the smart device 1 (122).

Here, the home device 2 and the smart device 1 may be connected through any one of NFC communication or Wi-Fi virtual AP mode. The connection scheme may be selected from an application of the smart device 1.

The smart device 1 selects the AP 3 to be accessed from the list received from the home device 2 and transmits information (e.g., an SSID of the selected AP) specifying the selected AP 3 to the home device 2 (132). If a separate password is required to access the AP, the user may input the password through an input interface of the smart device 1 and transmit the password along with the SSID (132). Alternatively, if the password regarding the AP 3 has already been stored in the smart device 1, the stored password may be transmitted along with the SSID (132).

After the information (SSID, password, etc.) required for accessing the selected AP 3 is received, the home device 2 terminates the AP registration mode (140) and transmits an access request to the selected AP (142). Since the AP 3 is initially located within the coverage A of the home device 2 and has all the SSID and password information required for accessing, the home device 2 and the AP 3 are successfully connected (150).

At the same time, the AP registration mode is also terminated in the home device control application of the smart device 1 (144).

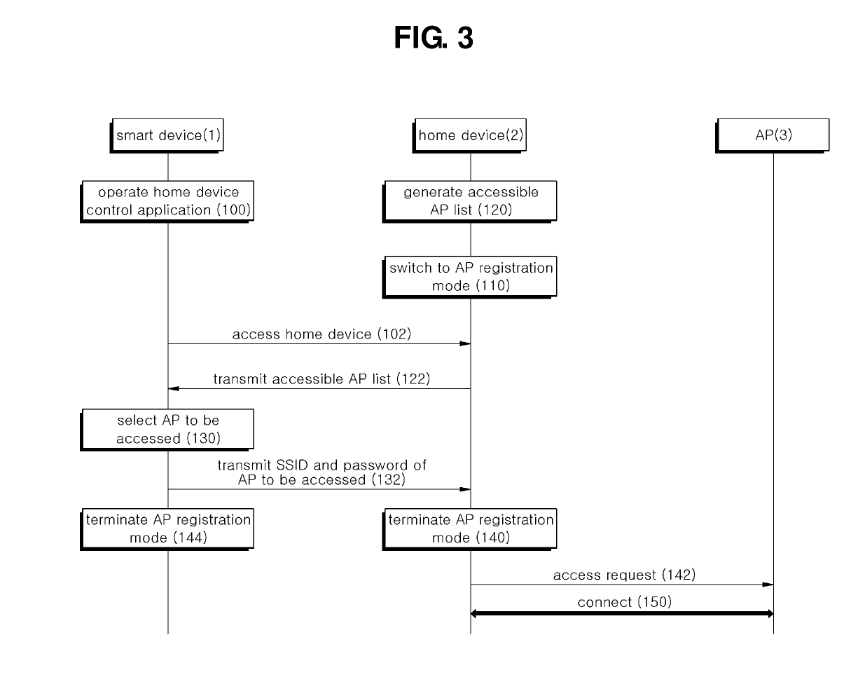

FIG. 3 is a flowchart illustrating another example of an AP access remote management method.

The embodiment of FIG. 3 is different from the embodiment of FIG. 2 in that the home device 2 generates a list of accessible APs even in a normal operation mode before the home device 2 is switched the AP registration mode (120).

In this case, since the accessible AP list has already been generated, when the smart device 1 is connected to the home device (102), the home device 2 may rapidly transmit the accessible AP list to the smart device 1 (122).

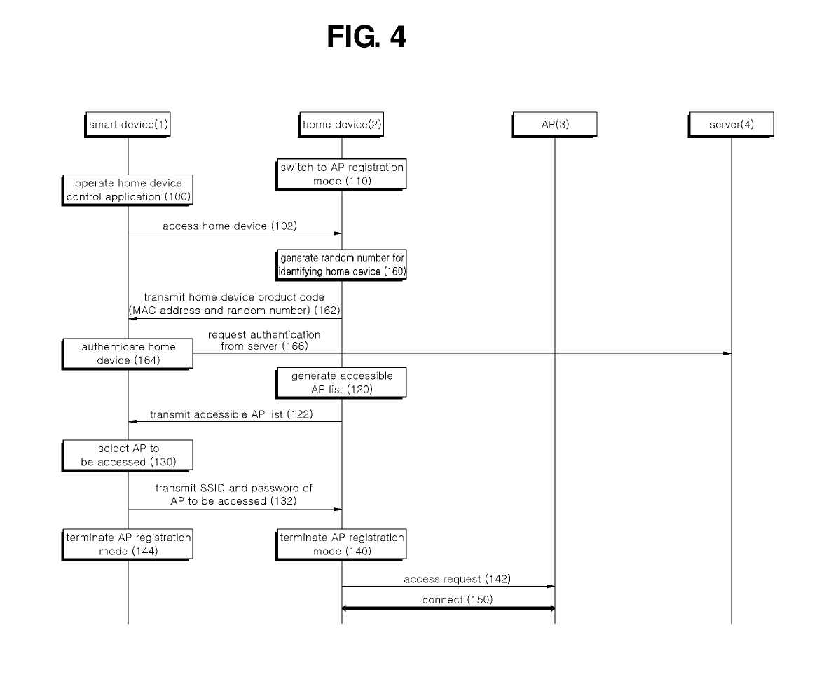

FIG. 4 is a flowchart illustrating another example of an AP access remote management method.

The embodiment of FIG. 4 is different from the embodiments of FIG. 2 and FIG. 3 in that an authentication procedure is performed through the server 4 so that only an authorized user may control the home device 2.

The server 4 in FIGS. 1 and 4 carries out authentication and member registration of the home device 2 and transmits a remote control command from a user remote controller. The server 4 further includes a database (not shown) storing a unique code of each of a plurality of home devices. The unique code may widely include information for uniquely identifying each home device. For example, the unique code may be any one or a combination of two or more of a serial number assigned to be different for each home device, a barcode number assigned to be different for each home device, and a MAC address assigned to be different for each wireless communication module.

The home device 2 itself generates a random number and transmits the generated random number and a unique code of the home device 2, such as a MAC address, to the server 4 via the smart device 1. The server 4 receives the random number and the unique code and compares the random number and the unique code with a random number and a unique code of the home device 2 already stored in the database of the server 4 to perform authentication as to whether the user of the smart device 1 has authority to use the home device. As information for identifying the user, a user ID and a user password may be used and may be transmitted to the server 4 together with the random number and unique code of the home device 2 in the step 164 of performing home device authentication.

When the smart device 1 requests authentication from the server through the above procedure (166) and the home device 20 is successfully authenticated (164), the home device 20 generates an accessible AP list 120 and transmits the generated list to the smart device 1 (122).

The smart device 1 selects an AP 3 to be accessed from the list received from the home device 2 (130) and transmits information (e.g., an SSID of the selected AP) specifying the selected AP 3 to the home device 2 (132). If a separate password is required to access the AP, the user may input the password through an input interface of the smart device 1 and transmit the password along with the SSID (132). Alternatively, if the smart device 1 has already stored the password regarding the AP 3, the stored password may be transmitted along with the SSID (132).

After the information (SSID, password, etc.) required for accessing the selected AP 3 is received, the home device 2 terminates the AP registration mode (140) and transmits an access request to the selected AP 3 (142). Since the AP 3 is located within the coverage A of the home device 2 and has all the SSID and password information required for accessing, the home device 2 and the AP 3 are successfully connected (150).

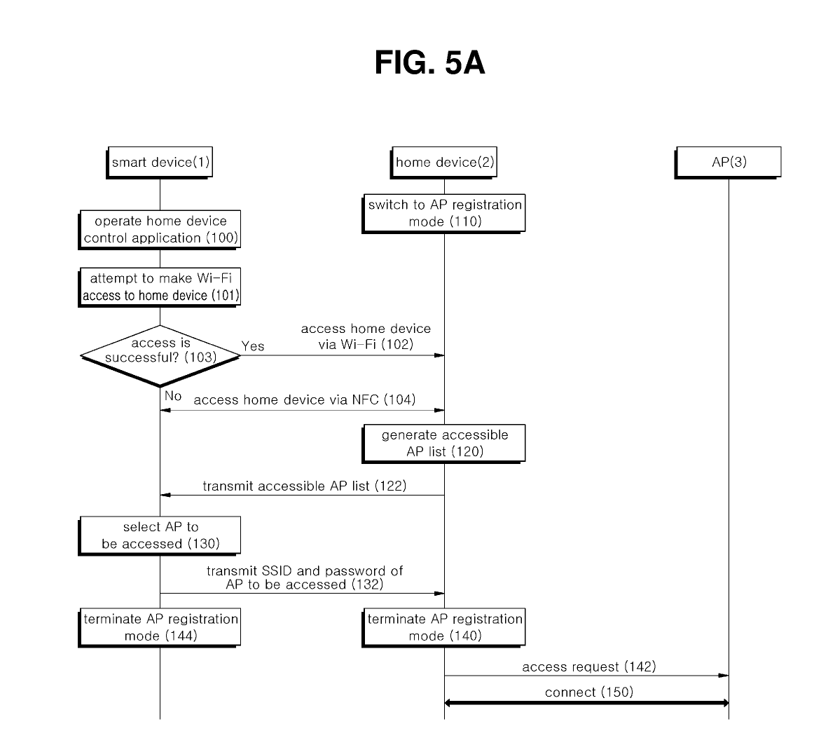

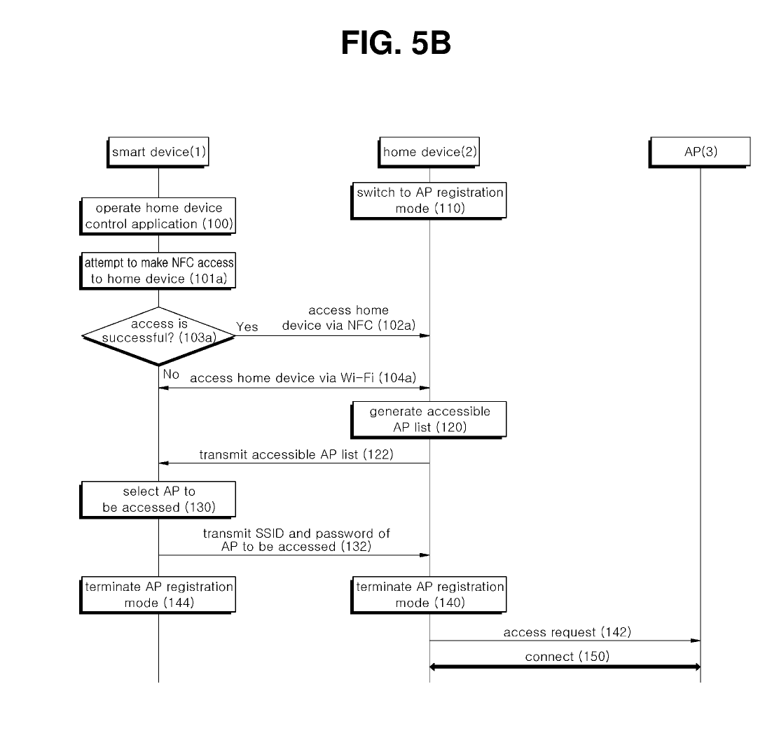

FIG. 5A is a flowchart illustrating another example of an AP access remote management method.

In the above, it has been mentioned that the smart device 1 may access the home device 2 via either NFC connection or Wi-Fi connection with reference to FIG. 1. FIG. 5A is another embodiment related to this.

In the embodiment of FIG. 5A, when a home device control application of the smart device 1 is operated (100), the smart device 1 attempts to make a Wi-Fi access to the home device 2 (101) which has been switched to the AP registration mode (110).

If the access is successful, the smart device 1 is connected to the home device 2 using Wi-Fi (102), and thereafter, the procedure for selecting an AP is performed in the same manner as in FIG. 2.

However, if the access is not successful (103), the smart device 1 activates NFC communication with the home device 2 (104). Here, all the subsequent procedures 120, 122, 130, 132, 140, 142, 144, and 150 are the same as those in FIG. 2, except that a communication protocol used in data transmission and reception steps 122 and 132 is an NFC scheme instead of the Wi-Fi scheme.

Meanwhile, the procedure in which the smart device 1 attempts to perform Wi-Fi communication with the home device 2 and the procedure in which the smart device 1 attempts to perform NFC communication may be implemented in a changed order.

FIG. 5B is a flowchart illustrating another example of an AP access remote management method.

Referring to FIG. 5B, when the home device control application of the smart device 1 is operated (100), the smart device 1 attempts to make an NFC access to the home device 2 (101a). As the home device 2 enters an NFC reception mode, the home device 2 is switched to the AP registration mode 110, and if the access is successful, the smart device 1 accesses the home device 2 using an NFC communication protocol thereafter (102a).

If, however, the access is not successful (103a), the smart device 1 attempts to make a Wi-Fi access to the home device 2 (104a).

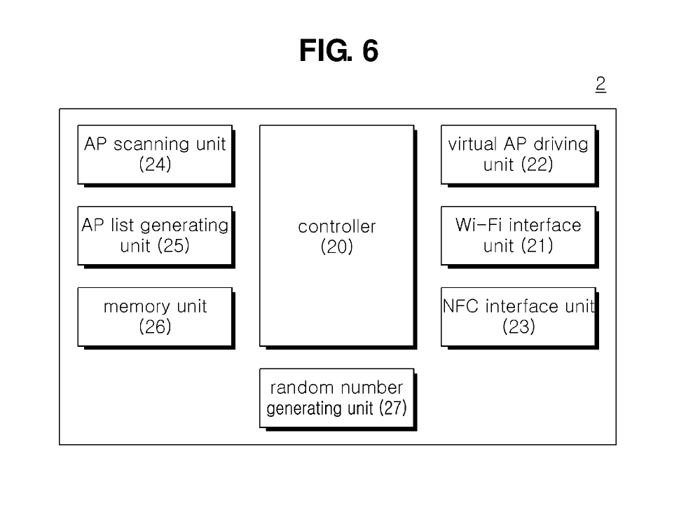

FIG. 6 is a block view illustrating an example of a home device in which an AP access remote management method is performed.

As illustrated in FIG. 6, the home device 2 in which the AP access remote management method is performed includes a controller 20, a Wi-Fi interface unit 21, a virtual AP driving unit 22, an NFC interface unit 23, an AP scanning unit 24, an AP list generating unit 25, and a memory unit 26.

The controller 20 controls a general operation required for performing the AP access remote management method.

The Wi-Fi interface unit 21 transmits and receives data to and from other APs and smart devices on the basis of Wi-Fi communication.

The virtual AP driving unit 22 implements a function of an AP in the home device 2 so that smart devices may access the home device 2 through the Wi-Fi interface unit 21. The virtual AP driving unit 22 generally implements the function of the AP by software, but implementation of virtual AP driving unit 22 of FIG. 6 as hardware AP is not excluded.

The AP scanning unit 24 collects information on APs existing within a range to which the home device 2 is accessible. The information of the collected APs includes SSIDs, received signal strength indicators (RSSIs), and security schemes of the APs.

The AP list generating unit 25 generates a list of accessible APs on the basis of the information of the collected APs.

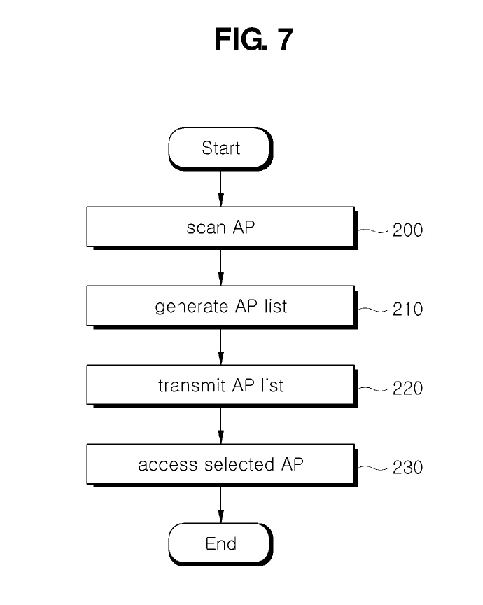

The AP list may be generated such that the collected APs are randomly listed, or a sorting principle of APs may be set and the collected APs may be listed according to the principle as described hereinafter with reference to FIG. 7 and the following figures.

The memory unit 26 stores programs such as software and firmware required for the operation of the home device 2 and data generated during execution of the program. Further, the memory unit 26 stores a unique code of the home device 2.

Meanwhile, in case where a unique code and a random number are used for authentication of the home device 2, the home device 2 may further include a random number generating unit 27.

The random number generating unit 27 generates a random number used for authentication of the home device 2. A random number generated by the random number generating unit 27 may be stored in the memory unit 26. The generated random number may be transmitted together with the unique code to the server 4 via the smart device 1 as described above with reference to FIGS. 5A and 5B.

FIG. 7 is a flowchart illustrating an example of an AP access remote management method performed in a home device.

The AP access remote management method of FIG. 7 includes an AP scanning step 200, an AP list generating step 210, an AP list transmitting step 220, and a selected AP accessing step 230.

The home device 2 performs an AP scanning step 200 to collect information regarding APs present within an accessible range. The information of the collected APs includes SSIDs, RSSIs, and security schemes of the APs.

Next, the home device 2 generates a list of accessible APs on the basis of the information of the collected APs (210). The AP list may be generated such that the collected APs to be randomly listed, or a sorting principle of APs may be set and the collected APs may be listed according to the principle.

The home device 2 transmits the generated AP list to the smart device 1 connected to the home device 2 via Wi-Fi or NFC.

Thereafter, when an AP to be accessed is selected in the smart device 1 and an SSID and password information regarding the selected AP 3 are transmitted from the smart device 1, the home device 2 accesses the AP 3 using the SSID and the password information.

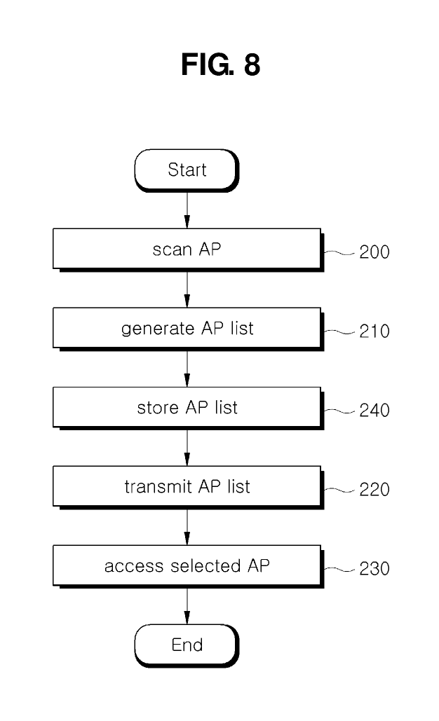

FIG. 8 is a flowchart illustrating another example of an AP access remote management method performed in a home device.

The embodiment of FIG. 8 is different from the embodiment of FIG. 7 in that step 240 of storing the AP list is added after step 210 of generating the AP list by the home device 2.

In this manner, the home device 2 may store the AP list in the memory unit 26 and then transmit the stored AP list to the smart device 1 upon request.

Descriptions of other steps are the same, and thus, will be omitted.

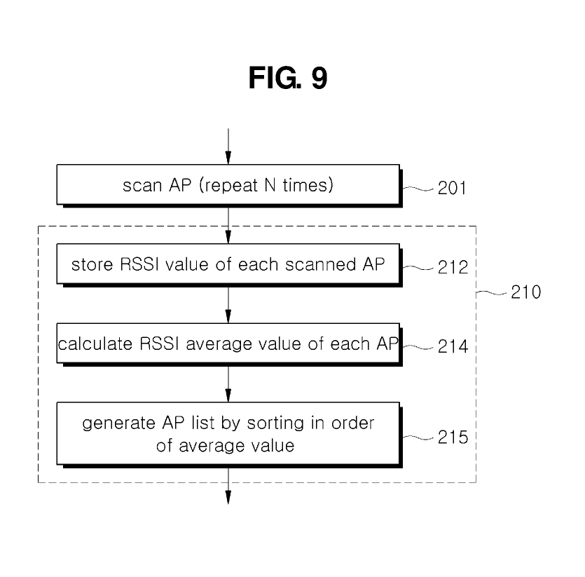

FIG. 9 is a flowchart specifically illustrating an example of a procedure 210 for generating an AP list.

As illustrated in FIG. 9, the AP list may be generated by sorting the APs on the basis of average values of received signal strength indicators (RSSIs) of respective APs.

This considers the fact that RSSIs of the APs may vary slightly with time.

Specifically, it may be set such that the home device 2 repeats the AP scanning step by a predetermined number of times (N times: N is an integer of 1 or 2 or greater) (201).

In this case, each time AP scanning is performed, the step of storing signal strength (RSSI value) of each of the scanned APs is performed N times (212).

When the step of scanning APs and storing RSSI values N times is completed, average values of the RSSI values measured for the respective APs are calculated (214).

Thereafter, the AP list is generated by sorting the APs in order of the average values (215).

Through this, in case where a plurality of accessible APs are present, the home device 2 may access an AP anticipated to have excellent signal strength (i.e., an RSSI), whereby quality and stability of communication may be enhanced.

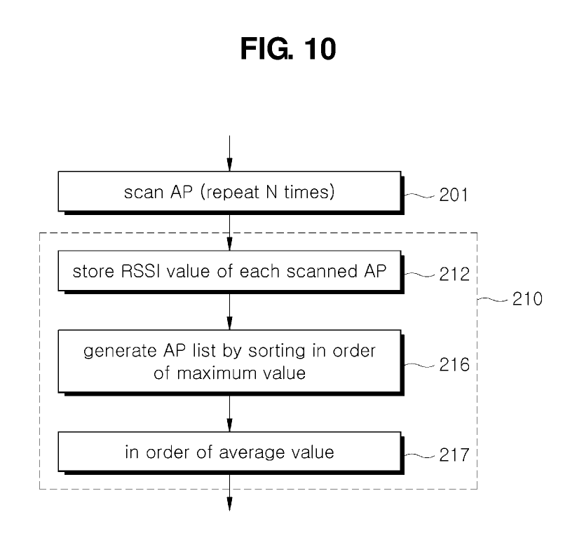

FIG. 10 is a flowchart specifically illustrating yet another example of a procedure 210 for generating an AP list.

Referring to a difference between FIGS. 9 and 10, the AP list is generated on the basis of the average values of the RSSIs of APs in FIG. 9, whereas an AP list is generated on the basis of maximum values of RSSIs of APs in FIG. 10.

The home device 2 performs AP scanning N times as in FIG. 9 (201).

Also, each time AP scanning is performed, the step of storing signal strength (RSSI value) of each of the scanned APs is performed N times (212).

When the step of scanning APs and storing RSSI values N times is completed, maximum values of RSSI values measured for each AP are selected (216).

Thereafter, the AP list in which the APs are sorted in order of the maximum values is generated (217).

Also, in FIG. 10, in case where a plurality of accessible APs are present, the home device 2 may access an AP anticipated to have excellent signal strength, whereby quality and stability of communication may be enhanced.

Although the embodiments of the present invention have been described with reference to the accompanying drawings, it will be apparent to a person skilled in the art to which the invention pertains that various changes in forms may be made without departing from the spirit or essential features of the present invention. Therefore, the foregoing specific embodiments are intended to be illustrative in all aspects rather than limiting. The scope of the present invention shall be defined by the appended claims rather than the foregoing description and it should be interpreted that the present invention shall extend to all modifications or changes derived from the definition, ranges, and equivalents of the claims.
1: smart device
2: home device
3: AP
4: server
20: controller
21: Wi-Fi interface unit
22: virtual AP driving unit
23: NFC interface unit
24: AP scan unit
25: AP list generating unit
26: memory unit
27: random number generating unit

1. A home device in which an access point access remote management method is implemented, the home device comprising:
a first communication interface unit transmitting and receiving data to and from an access point (AP) and smart devices on the basis of Wi-Fi communication;
a virtual AP driving unit implementing an AP function to allow a smart device to be connected via the first communication interface unit;
an AP scanning unit collecting information of APs present within an accessible range by the first communication interface unit;
an AP list generating unit generating a list of the APs on the basis of the collected information of the APs;
a memory unit storing a program such as software or firmware required for an operation, data generated during execution of the program, and a unique code; and
a controller controlling a general operation required for performing the AP access remote management method.

2. A home device in which an access point access remote management method is implemented, the home device comprising:
a first communication interface unit transmitting and receiving data to and from an access point (AP) and smart devices on the basis of Wi-Fi communication;
a virtual AP driving unit implementing an AP function to allow a smart device to be connected via the first communication interface unit;
a second communication interface unit transmitting and receiving data to and from the AP and the smart devices on the basis of a near-field communication (NFC) protocol;
an AP scanning unit collecting information of APs present within an accessible range by the first communication interface unit;
an AP list generating unit generating a list of the APs on the basis of the collected information of the APs;
a memory unit storing a program such as software or firmware required for an operation, data generated during execution of the program, and a unique code; and
a controller controlling a general operation required for performing the AP access remote management method and selecting a communication interface to perform communication with the smart devices from among the first communication interface unit or the second communication interface unit.

3. The home device of claim 1 or 2, wherein
the information of the APs includes service set identifications (SSIDs) of the APs.

4. The home device of claim 3, wherein
the information of the APs further includes received signal strength indicator (RSSI) values of the APs.

5. The home device of claim 4, wherein
the AP list is generated by sorting in order of magnitudes of average values of RSSI values of the respective APs measured two or more times.

6. The home device of claim 4, wherein
the AP list is generated by sorting in order of magnitudes of maximum values of RSSI values of the respective APs measured two or more times.

7. The home device of claim 1 or 2, further comprising:
a random number generating unit generating a random number used for authentication using an external authentication server.

8. An access point access remote management method comprising:
collecting information regarding access points (APs) present within an accessible range;
generating a list of the accessible APs on the basis of the collected information of the APs;
transmitting the generated AP list to a connected smart device;
receiving information of an AP to be accessed from the smart device; and
accessing the AP to be accessed using the information of the AP to be accessed.

9. The access point access remote management method of claim 8, further comprising:
executing a near-field communication (NFC) reception mode to allow the smart device to be connected, before the transmitting the AP list to the smart device.

10. The access point access remote management method of claim 9, further comprising:
when connection to the smart device via an NFC protocol is not established after execution of the NFC reception mode, switching an operation mode to an AP registration mode implementing a function of an AP to allow the smart device to be connected.

11. The access point access remote management method of claim 8, further comprising:
switching an operation mode to an AP registration mode implementing a function of an AP to allow the smart device to be connected, before transmitting the AP list to the connected smart device.

12. The access point access remote management method of claim 11, further comprising:
terminating the AP registration mode and returning to a normal operation mode, after receiving the information of the AP to be accessed.

13. The access point access remote management method of claim 11, further comprising:
when the smart device is not connected after the operation mode is switched to the AP registration mode, executing an NFC reception mode to allow the smart device to be connected.

14. The access point access remote management method of claim 8, wherein
the information of the AP to be accessed includes a service set identification (SSID).

15. The access point access remote management method of claim 14, wherein
the information of the AP to be accessed further includes a password of the AP to be accessed.

16. The access point access remote management method of claim 8, wherein
the generated AP list is transmitted to the smart device via Wi-Fi connection, and the information of the AP to be accessed is received from the smart device via Wi-Fi connection.

17. The access point access remote management method of claim 8, wherein
the generated AP list is transmitted to the smart device via NFC connection, and the information of the AP to be accessed is received from the smart device via NFC connection.

18. The access point access remote management method of claim 8, wherein
the AP list is generated by sorting in order of magnitudes of average values of RSSI values of the respective APs measured two or more times.

19. The access point access remote management method of claim 8, wherein
the AP list is generated by sorting in order of magnitudes of maximum values of RSSI values of the respective APs measured two or more times.

20. The access point access remote management method of claim 8, further comprising:
generating a random number used for authentication using an external authentication server; and
transmitting the generated random number and a unique code to the smart device.
